(19) United States
(12) Patent Application Publication
(10) Pub. No.: US 2011/0072367 A1
(43) Pub. Date: Mar. 24, 2011

(54) THREE DIMENSIONAL DIGITALLY RENDERED ENVIRONMENTS

(75) Inventor: Brian Bauer, Basking Ridge, NJ (US)

(73) Assignee: etape Partners, LLC, Fair Hills, NJ (US)

(21) Appl. No.: 12/890,490

(22) Filed: Sep. 24, 2010

Related U.S. Application Data
(60) Provisional application No. 61/245,587, filed on Sep. 24, 2009.

(51) Int. Cl. G06F 3/048

(52) U.S. Cl. 715/757

(57) ABSTRACT

A virtual environment program, method and system are provided that allow avatars representing users to interact in different ways within the virtual environment. A medical consultation environment is provided. A simulated environment with different virtual rooms, and different interactive functionality associated with different rooms is provided. Additionally, verbal communications between participants are determined based on physical separation of avatars and other location information.

### REFERENCE TO RELATED APPLICATION

The present invention is related to and claims the benefit of U.S. Provisional Patent Application No. 61/245,587, filed on Sep. 24, 2009, and entitled “3D Digitally Rendered Environments.”

### FIELD OF THE INVENTION

The present invention relates generally to digitally rendered environments, and more particularly to digitally rendered environments such as virtual reality environments where avatars represent professionals and/or clients who are permitted to interact through avatars in a virtually rendered space to enhance spontaneous exchanges of information, learning and the in depth understanding of problems or conditions.

### BACKGROUND OF THE INVENTION

The Internet has become a popular medium through which much of our traditional social functions are being conducted. E-commerce applications are making personal shopping, business-to-business transactions and interpersonal communication easier than ever. Internet-based electronic auctions allow professionals and individuals to post items for sale onto an electronic auction block for which other members of the Internet community may provide competitive bid prices. Electronic interpersonal communications have become common place as individuals and corporations communicate and conduct business with one another through e-mail, online telephony, video conferencing, and other new emerging communication products employing the Internet.

Despite the widespread acceptance of the Internet, the majority of Internet communications constitute point-to-point communications that do not occur in real-time. Such point-to-point communication occurs when a single entity (person or business) communicates with only one other entity. Thus, electronic point-to-point conversations do not occur in real time and are not available to be seen or heard by anyone other than the two participants within a particular communications domain.

In an electronic auction context, a single server computer may be used to list a particular item for world-wide bidding. However, the multiple users of the electronic auction system do not interact with one another simultaneously and in real-time, as would typically be the case when an item is introduced on an auction block in the real world. Simultaneous, real-time visual and aural perception of large multi-user communities have heretofore not been provided for by any software or computer systems currently in use on the Internet.

Digital form-based chat rooms and shopping malls are examples of Internet-based multi-user systems in which relatively small numbers of simultaneous users communicate with each other over the Internet. A “digital form”, can refer to the physical incarnation of an online user in the environment. The digital form may be a scanned image of the user's face, for example, or a more complicated computer-generated caricature for use by the participant. Such systems are limited, however, in that only a relatively small number of simultaneous participants typically communicate at any one time.

Further, a practical graphical limit to the number of simultaneous users is present with respect to various aspects of the transactional ability of computer systems. One difficulty is that a large a number of users may typically overrun the ability of any system to provide simultaneous, real-time communication and interaction particularly when graphics and three dimensional (“3D”) digital forms and environments are involved. Various embodiments may contain computer software and hardware systems directed to a large scale multi-user transaction system that facilitates online communication between multiple parties on a simultaneous, real-time basis. A large scale multi-user system of the type needed would support online user communities in which numerous simultaneous users are present within the community and are capable of both aural and visual perception.

One complication in the implementation of a massively multi-player interactive game is the design and implementation of a computer system which can efficiently administer thousands of remote participants in an online community. Two problems to be solved in designing such a system include: (1) creating an efficient system architecture for supporting a large number of simultaneous users; and (2) load balancing the users' transactions among computer servers. Typical computer systems may load balance the number of transactions evenly across all computer servers. This load balancing arrangement may not be desirable in a computer system implementing a environment, however, since each server would have to possess a replication of the entire in all its transactional variation.

A user's enjoyment in participating in an online multi-player game is directly related to the quality of the game playing experience, which depends on various factors such as the graphics, audio and interactive activities provided by the game application software. The quality of the graphical presentation, in turn, depends in part on the game software and in part on the quality of the network connection linking the player's PC and the game computer server.

### SUMMARY OF THE INVENTION

According the present invention, digital form-centric communication, expression and display are provided for a multi-user online simulation that provides a virtual reality for participants using avatars to allow real time interaction between and among participants based on location in the virtual space. According to one embodiment of the invention, a method of providing a medical consultation in a virtual environment includes: providing an avatar representing a medical professional and a patient; providing an appointment room; allowing the medical professional access to patent medical information through the virtual environment; and depicting visual information regarding the patient's condition in the virtual environment. The method may further include establishing voice communications between the patient and the medical professional through the virtual environment. It may still further include presenting, based on medical information associated with the patient and medical treatment information provided by the medical professional, a predictive visual display relating to the patient's health and treatment.

According to another embodiment of the invention, a method of providing a virtual environment that includes multiple virtual rooms and areas for interaction among avatars, includes providing at least one virtual lounge area; at least one virtual meeting room; and permitting users to select, via an avatar and a browser tool in the virtual environment, a virtual lounge or virtual meeting room to join. The avatar's proximity and location may be used to select whether voice communication is possible between corresponding users and the volume level for the conversation.

In one embodiment, a user accesses the internet or a computer application to utilize a environment in order to: chat with other users, shop, coordinate health care, interact with companies, play games, coordinate finances, transportation, education etc.

Computer games and arcade games often feature animated, user-controlled characters which represent human users and which appear human or humanoid. These characters are referred to as “digital forms”. Currently, there is growing interest in creating an on-line community in which people are represented by digital forms and can interact with each other in a environment (a simulated environment) through their digital forms in a realistic manner. Ideally, the environment may provide sufficient “richness” so that the digital forms can interact with each other and their environment in much the same way people interact in the real environment. The availability of the Internet makes such a environment potentially accessible to millions of users. Such a environment may impact many areas of everyday life, including communications, entertainment, commerce, and education, to name just a few. The usefulness and success of an digital form-based community may depend largely on the sophistication and realism of the digital forms and the ways in which they can interact. Users may want to use and participate in such applications only if their digital forms are realistic and sophisticated in their capabilities.

While users of a environment may want to engage in various activities, such as racing a car or flying around the environment in a plane, one of the most compelling and desired activities is communicating with other users. Thus, one of the principal features common to known three-dimensional (3D) environments is the ability for different users of the environment to communicate with one another, through text chat. In known 3D environments, conversation has been presented in a way that is no different from online text conversations without a 3D environment, using instant messaging and email, where text is presented in a 2D window, separating it from the 3D environment. Known 3D environments do not provide digital forms with body language, facial and gestural expression, or 3D symbolic visuals for user-to-user communication. To provide users with a rich user experience in a environment, it is desirable to make digital forms' faces and bodies important components in user-to-user digital form communication, as in the real environment.

In previous 3D environments, conversation has been presented in a way that is no different from online text conversations without a 3D environment, using instant messaging and email. The presence of digital forms has essentially been ignored in the design of communication. Displaying chat text in a 2D window separates it from the 3D environment, and thus it cannot be used as an “extension of body language”. Some of the techniques introduced herein address these issues by coordinating various communicative elements in-environment, within a comprehensive structural system. Some of the techniques introduced herein embed textual conversation into the 3D space of the digital forms, and use cinematic cameras to facilitate conversation and add drama to these conversations.

A related aspect of the present invention pertains to a method of creating a visual display on at least one display screen, where the visual display includes information about a multi-user game. The at least one visual display may be reviewed and monitored remote from user computer displays by an administrator of the present game. The method preferably comprises a utilizing a plurality of environment-server complexes to create unique environments in which a user can interact with other users through digital forms, operated by user computers connected to the environment server complexes. A method also comprises utilizing an administration server connected to the plurality of environment server complexes and the plurality of user computers through a telecommunications network. A visual display is provided on at least one display screen, where the visual display includes a environment status area which identifies a plurality of environments and information about the number of user computers logged into the plurality of environments.

A method may comprise displaying information about the number of users who have submitted questions about the game within the environment status area. The users of the game may be assigned at least one status level based on their achievements within the game. The method may further comprise displaying information within the environment status area about the quantity of users at particular status levels logged into the plurality of environments.

The method may also comprise displaying a computer system status area within the visual display on at least one display screen, where the computer system status area identifies information about the number of users utilizing the computer system. A telecommunications status area may be displayed within the computer system status area, wherein the telecommunications status area includes information about the number of packets of data being sent and received through the telecommunications complex of the computer system.

### BRIEF DESCRIPTION OF THE FIGURES

The above described features and advantages of the present invention may be more fully appreciated with reference to the attached Figures described below.

FIG. 1 depicts an illustrative system architecture in which an embodiment of the present invention may be deployed.

FIG. 2 depicts an illustrative method of interaction in a virtual environment between a patient and a medical professional

FIG. 3 depicts an illustrative method of interaction between a user's avatar and other avatar's in a virtual environment that permits interaction in various formal and informal communication settings.

### DETAILED DESCRIPTION

A fully immersive 3D virtual experience is provided in various embodiments in which a user adopts the persona of a character (avatar) that exists in a software based “world” designed to have the look and feel of a physical office or learning institution. The users of Virtual Reality technology operate in the 3D space and see objects and people from the Point of View of their avatar inside the technology. Activities inside the Virtual Reality environment:
Meetings, in which a collection of avatars collocate in a virtual meeting room with the look and feel of a physical meeting. Audio is provided by integrated conference bridges.
Instruction/Assessment, in which teachers are able to interact with students in an authentic way. The use of avatars an realistic activity makes role-play based teaching and testing a powerful exercise in engagement
Learning, game-play embedded in the Virtual Reality technology creates a framework for self-study. Study that combines an immersive environment with fun has been demonstrated to improve interest in self-study as well as data retention rates.
Structured and Unstructured Coworker encounters, Virtual Reality technology enables groups of people who may be physically separated to come together for formal and informal get-togethers. Frequent, and often unstructured encounters with colleagues help to recreate some of the advantage that is lost when associated coworkers become physically separated.

Terms that are used in the present application to describe virtual environments such as those identified above.
Physically Disparate: A situation in which employees are separated by physical distance.
Immersive Technology: Technology that enables the user to have a point of view from within a software rendering of a virtual space.
Virtual World: A virtual rendering of an environment based on Immersive Technology.
VCEBT: Virtual Corporate Environment Business Tool.
Virtual Reality: A realistic simulation of an environment by a computer system.
Federated Reality: The relationship between a person's consciousness and their physical body.
Avatar: A rendering that represents the user in a Virtual World.
VCE: Virtual Corporate Environment.
Formal Encounter: When colleagues encounter each other in a planned scenario, quite often defined by an agenda.
Informal Encounter: A chance encounter of two or more colleagues.
Proximity: How we describe the sense of “being with” a colleague.
Customer Intimacy: Having an in depth and meaningful understanding of a customer.
Flex Time: When employees do not all work the same daily hours.
BPI—Business Process Improvement: The analysis and improvement of business workflows.
Authentic Learning: Learning by doing.
Andragogy: The engagement of the Learner in the process of learning.
Serious Game: An activity that uses game play to teach important educational concepts.

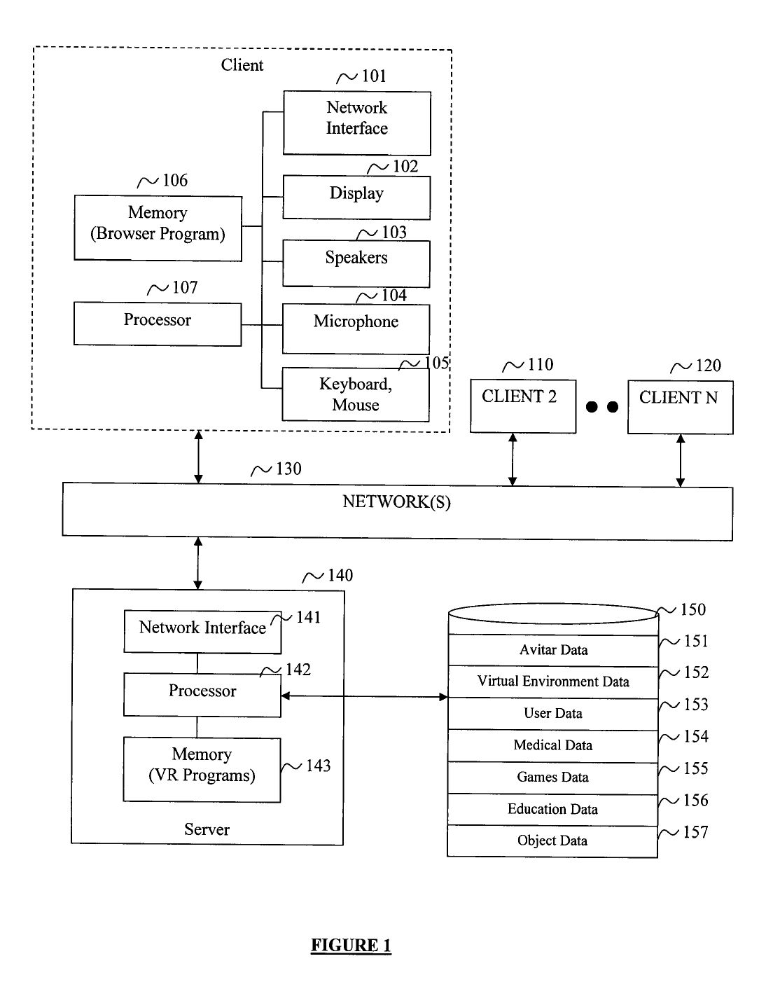

FIG. 1 depicts an architecture that may advantageously be used to provide a virtual reality environment to a community of users. The user community may be the public at large, or a particular organization or group. The architecture generally provides a plurality of client computers 100, 110 and 130, which may be very numerous, that interact with one or more servers 140 to exchange data and project the user's avatar into the virtual environment and allow it to interact with other users' avatars according to the various embodiments described herein. The server 140 may be distributed or centralized and each server may interact with one or more databases 150.

Each client computer may include, for example a processor 107 that communicates with a memory 106, a network interface 101, a display 102, speakers 103, a microphone 104 and a keyboard, mouse, touch screen or other user input or input/out device. The memory stores programs and data. The programs program instructions that are executed by the processor to provide various functionality described herein. The programs may include, for example, a browser program, an email and calendar suite program, file sharing, application sharing, communications programs including chat, voice over IP (VOIP) and other programs including plug ins to browsers and any other software programs described herein to permit an interface between the browser or other application and the virtual environment and virtual reality program.

The clients may be coupled to the server over the network 130. The server includes a processor, a network interface permitting communications of all types with the client computer (and the database 150). The server also includes a memory that stores various programs used by the virtual reality environment, including the environment itself and all related information, communications and other programs to permit users to interact, communicate and share information and filed in the virtual realm. The processor executes program instructions for the programs stored in the memory to carry out the various functions described herein.

The database 150 generally includes data that is used by the virtual reality program to provide the virtual environment and permit the interactions described herein. The database may include, for example, avatar data 151 that includes default data as well as avatar data specific to users. The virtual environment data may include data to establish and track each virtual environment and its virtual constraints and events and interactions that occur there. The user data may include information such as the user's authentication information, such as a userid and password, name, billing address, telephone number, email address and other identifying information. It also may include for the user data corresponding to the user's interactions with the virtual environment. The medical data may include information about each participating user's health, including drug allergies, health condition, demographic information, health history and other information, including medical files. Such information may be encrypted and maintained private to the user or others with whom the user chooses to share such information. The database may further include games data relating to programs for providing games or game data generated by game programs. The education data may include educational programs or materials that may be provided in the virtual environment. The object data may include information about an object, such as medicine and its properties and its effect on people for treating particular kinds of illness, among other things. The server may access data from the database at any time and store information back into the database as a result of ongoing use of the virtual environment.

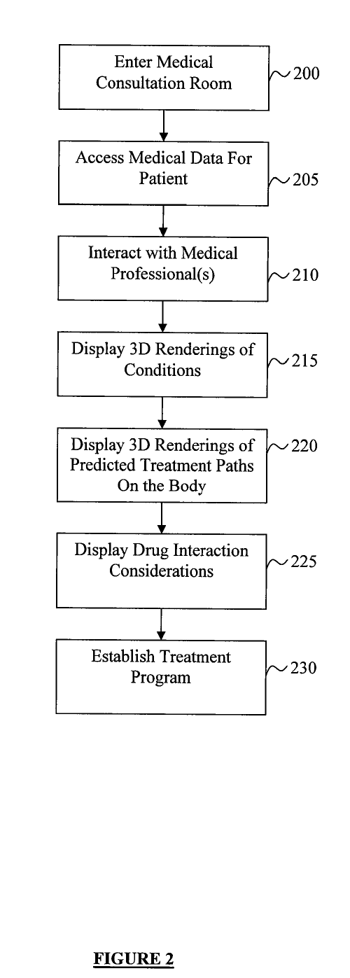

FIG. 2 depicts a flow chart corresponding to an interaction that may occur in the virtual reality environment to facilitate a patient seeking medical information and/or treatment in a virtual environment from a medical professional or through interaction with the virtual environment. Referring to FIG. 2, in step 200, the user enters a medical consultation room in a virtual environment. The medical consultation room may be provided with a media screen, a white board, an examining table and objects in the room, such as particular medicines. In step 205, when an avatar corresponding to the user enters the medical consultation room, the user's medical file is accessed. The user's medical file may be preexisting and the user may be prompted for permission to allow the virtual environment software to access the information. Alternatively, the user's medical information may be obtained by requesting the user to fill out medical information in response to specific questions. In still another embodiment, in step 210, the user's medical information may be obtained by another user, a medical professional, prompting the user to provide medical information in response to questions from the avatar conveyed via spoken communications between the medical professional and the user.

In step 210, the user may interact with the medical professional to obtain various treatment options to maladies affecting the user. In step 215, the user may learn about his or her condition identified by the medical professional through the user's receiving a 3 dimensional rendering of information about the user's medical condition rendered by the medical avatar in the virtual environment. This may include by the user receiving streaming video information, spoken information, or other materials provided through the virtual environment. This presentation may be personalized to the user's situation. The personalization may occur through the user's medical information and other information, including photographs or other data associated with the user being used to present the display in whole or in part.

In step 220, the virtual environment and consultation room may also include an area for presenting to the user's avatar three dimensional renderings of predicted treatment paths on the body. Again, this may be done using objects in the virtual room that interact with information found in the patient's medical information. For example, the patient may be told about certain medicine that the user can take. The medicine might be an object in the room. This medicine has data associated with it and such data may be applied to the user's medical condition information to predict and outcome that can be visually presented to the user. In step 220, For example, drug interactions with drugs the user is presently taking can be highlighted and explained. A presentation such as an animation of how the user currently feels as compared to how the user may be after treatment may be presented. In step 230, the user and the physician through the various treatment options presented may establish a treatment program that is conveyed through the virtual environment.

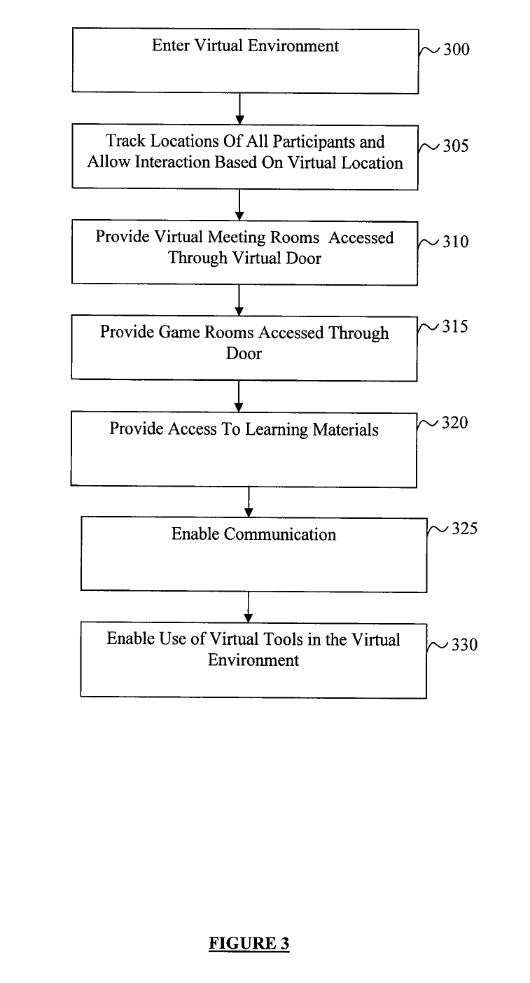

FIG. 3 depicts a user's interaction with a virtual environment that has different rooms and modes of interaction. Referring to FIG. 3, in step 300 a user via the user's avatar enters a virtual environment. In step 305, the virtual environment tracks all of the participants and allows interaction between the participants based on the virtual location of the participant's avatars. In step 310, virtual meeting rooms are provided which ay be accessed through virtual doors. The rooms may include conference rooms, consultation rooms, auditoriums and other types of rooms, including lounges. In step 315, a game room may be provided accessible through a door. In step 320, learning materials and other materials may be accessed by a user and provided to the user in the virtual environment or may be communicated to other user's in the virtual environment.

In step 325, voice and other communication may be enabled for each user in the virtual environment based on the user's location. The voice communication may be established based on the location of a user's avatar, for example in an auditorium, classroom, virtual meeting room, a lounge and based on how close the user's avatar is to other users. Additionally, there may be a broadcast mode, private modes and different channels all as described herein. In step 330, virtual tools may be enabled by user's avatars in the virtual environment, such as accessing browsers, looking at rooms and who is in those rooms, creating meeting rooms and meetings and other functionality.

According to one embodiment of the invention, the application is accessed through a web browser. The web pages and screens of the virtual environment may be generated using a server-side program, such as ASP.net. The web page may include, for example, a language and object format such as HTML, CSS, JavaScript and a browser plug-in to embed the application client. JavaScript may be enabled on the user's computer. Additional features of the plug in may include file upload/download features, communications interfaces, web browsing interfaces, and Internet based collaboration, file sharing and publishing tools.

The virtual environment may include a lounge environment that users or players of the virtual environment enter. The lounge may hold up to a certain number of users or avatars at a time, such as 50 and then the lounge maybe be instantiated as more users enter the environment with additional users entering the new lounge instances. Users can change between lounges, as long as the lounge not full.

Virtual meetings may be part of the virtual environment. Users can join meetings either by selecting a meeting tool or browser within the virtual environment (or an interface to that environment). Several meeting room doors can be used to browse and create virtual meetings. The meeting room doors that are present within the Virtual Lounge may include a Classroom door, Assessment Room door, a Conference Room door, and an Auditorium door.

While in the virtual world the user can access the in-game meeting browser by moving his or her avatar to a door and interacting with it. The type of meeting that may be created may be determined by the type of door that the user interacts with (e.g. Classroom/Assessment, Conference Room, and Auditorium). Other users can join a meeting, for example, using an in-game meeting browser, but only if meeting room is not full or the meeting is not set to private. The in-game meeting browser may display all meeting that are currently taking place. The user may be able to filter the list, search or undertake other actions to find a meeting. A join meeting button may be used to join a meeting. The user may also create a meeting through the in-meeting browser. The meeting may be instant or at a scheduled future time.

If the user selects to join the meeting by using the in-game meeting browser they may be instantly transported directly into the meeting currently in session. Attendees can, at any point, choose to leave a meeting. After selecting to leave a meeting, the former attendee may be transported to the Virtual Lounge. While in the Virtual Lounge, the former attendee can elect to rejoin the meeting or join a different meeting by using the in-game meeting browser.

When the meeting has concluded the meeting creator may be able to end the meeting by selecting an end meeting option. After this option has been selected, all of the meeting attendees may be transported to the Virtual Lounge and the meeting room may be deleted from both the virtual world and the in-game meeting browser list.

If an invitee is present in the virtual world at the time of an instant meeting starts, he or she may receive an onscreen pop-up meeting invitation. The invitation may display the details of the meeting and provide options to join or decline. If the invitee selects joins he or she may be transported seamlessly into the created meeting.

Meeting may be created through, for example, an in-game browser and selecting to create an instant meeting or a scheduled meeting. Alternatively, meetings may be created using an email service with a plug in that is integrated with the virtual environment. The email service with plug in may allow the create a meeting immediately and invite users that are currently in the virtual world. A scheduled meeting may allow for creation of a meeting in the future. Parameters of the meeting include a selection screen that allows users to set parameters of the meeting, select the required and optional attendees, and assign roles of the attendees within the meeting. When the user has selected their desired parameters, the user may click a “create” button to create the meeting. After the ‘Create’ button has been clicked, the meeting room may be created in the virtual world, meeting invitations may be sent to the selected invitees, and the meeting may be listed in the in-game meeting browser. For future meetings, the meeting may be created at the scheduled future time in the virtual environment.

A plug in according to one embodiment of the invention for use with email and scheduling meetings may include: an option within the email program to create a Virtual Meeting. After selecting a Virtual Meeting, the user may set the parameters of the following options: Meeting Type/Room; Attendees (same functionality as standard Outlook meeting requests); Attendee Roles; Time of Meeting; Length of Meeting; Private or Public Selection.

When the user has finished setting the parameters of the Virtual Meeting and has clicked on the Send button, a meeting request e-mail may be sent to all of the requested attendees. The meeting request e-mail may contain the details of the scheduled meeting along with a quick link to the meeting. When an invitee accepts an invite it may in the user's calendar and the user may receive reminders based on what parameters the creator has set. At the scheduled meeting time, a quick link may be used from the email/calendar application to allow the attendee to click on the link and be directly transported into the meeting room. The same mechanics are used when the user is in game and selects to create a scheduled meeting. Microsoft Outlook is an example of an email/calendar program that may be used with a plug in to achieve the above described functionality.

When the creator joins the meeting, the creator may be prompted to upload and attach any documents that they would like for the meeting. After the meeting room has been created, users can also select to join the meeting through the virtual world by using the in-game meeting browser.

There may be multiple instances of lounges. A lounge browser within one or more virtual lounges may allow the user to browse different lounges. Upon launching the application the user is automatically placed within a lounge instance based on its availability. If multiple lounge instances are available for the user to join, they may randomly be placed within an available instance. The user can join any other lounge instances by using an in-game lounge browser. The in-game lounge browser can be accessed by navigating to the in-game meeting browser and clicking on the lounge browser button.

Users and their avatars may acquire additional interface options that are only available while they are attending a meeting. The additional options that are available may be determined by the user's role in the meeting. In addition to the options available to all meeting attendees, presenters may have the ability to present media, invite additional users to the meeting, and put an end to the meeting.

The presenter may be provided with the following interface options: Laser Pointer; Invite Attendee; End Meeting; Exit Meeting; Stand Up; Raise Hand. An attendee may have the following additional interface options: Laser Pointer; Exit Meeting; Stand Up; Raise Hand; When the user is in the seated position, two additional buttons may appear on the user's screen. These buttons are user action buttons and consist of a ‘raise hand’ button and a ‘stand up’ button. If the user clicks on the ‘raise hand’ button, the user's avatar may perform a raise hand animation. When the user clicks on the ‘stand up’ button the user's avatar may push their chair back, perform a standing animation, and enter into the standing state. While in the standing state, the user may not have the meeting action buttons on screen.

If the presenter wants to invite additional users to a meeting that is currently in progress, he or she can click on the invite button on the screen. When user clicks on the invite button, the user is presented with the invite interface. This interface is similar to that in Microsoft Outlook when clicking on the To button within an e-mail. The user may highlight a name from a list of people in a user's contact list or within a company contact list. The number of allowed attendees may be determined by the selected meeting type.

The user can use the mouse cursor to highlight the media presentation screens in the virtual environment. If the user clicks on the left mouse while a media presentation screen is highlighted they may interact with the media screen. The media interaction interface is determined by the user's role in the meeting.

When a presenter interacts with a media screen, they may have a full screen view of the media screen and may have the ability to present and control meeting media. The presenter can present media by selecting a new media button, for example. After the presenter has selected media to present, they may be able to control and manipulate the media using the displayed interface. The interface options may be determined by type of media that is presented. When an attendee interacts with a media screen, they may have a full screen view of the media screen and may have the ability to close the full screen view.

A virtual conference room may be configured to hold a particular number of users or may be expandable. The room may hold a particular number of users as represented by each user's avatar at a time. Virtual conference rooms may make use of the following features: document and application sharing among attendees, a white board visible by all attendees, AAR and voice over IP (voip) to permit attendees to speak and listen in a conference call mode, for example, with those in the conference rooms or in other modes.

Users through their avatars may join an auditorium. Those who are not the Presenter, may be shown a seat-selection interface allowing the user to click on a desired seat. The seat-selector may be updated in real-time as other users select their seats. Once a seat is selected the user is transported to their selected seat and sees a perspective view from that seat of a the 3D Auditorium environment. The following rules may apply while in the Auditorium:

At any time before meeting start the user can return to the 2D seat-selector and choose a new seat, if available. The user is able to free-look in a set degree rotation; left, forward, and right. The user may or may not be able to get up or move. Once the Host/Presenter of the Auditorium officially starts the meeting, seats may not be changed and seat-selection functionality may be disabled. The Presenter may be placed on the stage and may or may not be able to move off of the stage. As the user looks around with the mouse, he/she can see surrounding avatars. The level of detail may be higher for nearby avatars and lower for more distant avatars. For example, at close range the user may see 3D avatars playing idle animations. At medium distance, the user may see 3D avatars with reduced polygons and texture depth and no animations. At long distance, the user may see images of avatars that are billboards with textures on them to simulate 3D depth.

The Host/Presenter may have the ability to open the meeting up to questions. If a user would like to speak to the presenter or the crowd, to ask a question or comment, there may be a virtual ‘Microphone’ button. Pressing this button may put the user in a question queue, much like a town-hall meeting where a line of questioners step up to a microphone. The user can leave the question queue at any time. Users can hear other questions on the same Auditorium audio channel that they hear the Presenter. The user can view the question queue and see their place in line. Once a user reaches the top of the question queue an icon on their screen clearly indicates that they have the floor. At talk button may be pressed by the user to speak or may invoke the VOIP functionality in some other way to communicate speech to the auditorium. The user's question is broadcast to the main Auditorium audio channel.

Yet another venue that may be present in the virtual environment is a classroom. A classroom may hold a certain number of users at a time, such as 25 users. The number may be more or less depending on the implementation. This room makes use of the following features: Document/Application Sharing; Video Streaming; Whiteboard; AAR; and VOIP.

Yet another venue that may be present in the virtual environment is an assessment room. An assessment room may hold a certain number of users at a time, such as 25 users. The number may be more or less depending on the implementation. This room makes use of the following features: Document/Application Sharing; video Streaming; Whiteboard; AAR; and VOIP.

The application may include VOIP functionality to allow users to communicate with other users within the virtual world using a Voice Over IP system. The Voice Over IP communication system may be any system for making telephone calls, voice calls, or conference calls. The system may make use of a microphone and speaker of the user's computer. Alternatively, it may use routing technology to connect a microhone and speaker of a user telephone to the virtual environment.

This feature allows a user to broadcast his or her voice to the virtual environment. When this mode is operable, the user's voice is broadcast when the user speaks in the microphone. When the user is broadcasting a 3D graphic element may appear over the avatar of the broadcasting user in the virtual world to denote that the user is broadcasting. In addition, an onscreen icon may appear on the broadcasting user's screen to indicate that they are currently broadcasting. Both the onscreen indicator and the in-world icon may disappear when the user is no longer broadcasting.

The VOIP application with which the user communicates may allow multiple voice channels. The user may be able to select which channels to broadcast on and listen to by using a collapsible VOIP onscreen interface. When a user is in the Lounge the user may be able to join either a custom voice channel or a general voice channel. The appropriate tab of the VOIP onscreen interface may highlight denoting which voice channel the user is currently on.

The general voice channel makes use of a volume attenuation system which allows for the spatial representation of the broadcasting user's voice. After joining the general voice channel, the voice volume level heard by other users may be dependent their distance away from the broadcasting user within the virtual environment of the lounge or other area or room within the virtual environment. The volume may gradually decrease the further away the user is from a broadcasting user. While the user is in the general voice channel they may be able hear and broadcast to any other user, within the designated broadcast radius, that has also joined the general voice channel. The user may mute and adjust the volume of the general voice channel at anytime by using the VOIP onscreen interface.

The user may have the ability to create a custom voice channel and set which other users are able to join. The user can select which individuals to have in their private channel by accessing the VOIP onscreen interface and clicking on the individuals that they would like to be included in the private channel. The user can add and remove individuals from their private channel at anytime by using the VOIP onscreen interface.

When a user joins a custom voice channel they may hear voice broadcasting from the all of the individuals on that private channel. After the user has selected to broadcast on the custom voice channel, any voice broadcasting performed by the user may only be audible to the individuals that have joined the custom channel. This broadcast on the custom channel may not exhibit volume attenuation based on distance. The user can leave the custom voice channel at anytime by using the VOIP onscreen interface. While broadcasting on the custom voice channel, the in-world 3D graphic icon denoting voice broadcast may (or may not) only appear on the screen of users that are on the same custom voice channel.

A friend finder application may make use of a friend finder in the form of a filter system. The friend filter may function as a toggle button that may be available for inviting users to a private voice channel and inviting attendees to a meeting. When the button is toggled on, the in-world user list may display only the user's buddies (populated from the user's communicator buddy list) that are currently in the virtual world. When the button is toggled off, the in-world user list may display all of the users in the virtual world (unless the user name input has text within it). This button should change appearance based on its focus (e.g. one look when toggled on, another look when toggled off.). When the application is launched, this button may be toggled off by default. Buddy names may be color coded to show users where that buddy is located.

This application allows for meeting presenters to easily share media with meeting attendees during virtual meetings. In order to share media during virtual meetings, the user may, for example, have designated media saved in a .PDF format on their computer's local drive. At this point, the user may then copy documents to a designated server that is available to the virtual world application. After the files have been transferred, the user may share these documents by creating a meeting and designating the transferred files that the user would like share with the meeting attendees.

When a user elects to create a meeting, they may be presented with an interface in which they can select what media may be available during the meeting along with how the media may be displayed and shared by meeting attendees. The user can choose to begin the meeting after they have set all of the desired media and meeting parameters. After a meeting has been created, any associated meeting media may be copied onto a designated server and stored within a unique folder that may be named based on the details of the meeting. Other users can explore this folder and access any of the stored media.

When participants enter the meeting, a pop-up may prompt them to sync with the meeting folder. This may copy the files in the meeting folder to the participant's computer, and allow them to view these files in the virtual world. If a participant does not sync, media in the world may appear as a generic icon of that media's type.

Default avatars may be provided for user to select. For example, a series of unique trunks and torsos may be provided for males and females. Color and other variations may be provided to provide some ability to distinguish avatars based on the chosen bodies. Heads of people may be photographed or scanned and included for the characters or other head images may be made available. Additionally, sets of hair may be selected that include different colors and styles. Clothing options may be provided and avatars may be changed by users.

Animations may be created for the avatars to perform in the world. These may be any set of animations. However, a basic set of animations might include: Walking; idles (x3); Running; Strafing; Wave; Raise Hand; Interact; Use Laser Pointer; Point; Open Armed Gesture; Turning; Sitting; Standing.

All user authentications may be handled by the application or the website hosting the application. When reaching the game's web site, the user is presented with a login form where the ‘User Name’ and ‘Password’ may be entered. The web browser may transmit the login credentials to a web server, where for example an ASP.NET application authenticates the user against an active director of subscribers or participants within an organization. A Persistent Login system may use a web browser cookie that caches the login credentials in the user's web browser. If a user successfully authenticated in the past and enabled the Persistent Login feature, the login form is skipped on future web site visits. The Persistent Login feature can be enabled by the user using a ‘Remember Me’ checkbox on the login form. When the user manually logs out using a ‘Logout’ link on the web site, the Persistent Login feature is disabled.

Users may be able to perform a number of basic interactions in the world. A game may allow users to create their own learning content to be loaded into the game. This content may be entered into a file, which may populate predetermined areas with custom learning material. They may be able to navigate the virtual world using either the W, A, S, D keys or the arrow keys (with the exception of the Presenter this feature is not available in the Auditorium), they may be able to look around the world using the mouse and they may be able to open and close a number of available menus or options via hotkeys. Most of the menu options may also be available as UI interfaces.

While the user's avatar is in the standing position, they may be able to move around the virtual environment using either the W,A,S, and D keys or the arrow keys. When the user's avatar is in the seated position, only head movement is allowed. Movement input may not be accepted when a menu is in focus.

When the user presses and holds down the right mouse button, they may be able to move the mouse to move the avatar's head position and look around the environment. While the right mouse button is held the mouse cursor may disappear, the UI may fade out, and an indicator may change to denote that the view mode has changed. When looking up or down the user may have a limit on the angle in which they can move the view. The exact angle limit, when implemented, may be set at any desired value.

When the user moves their view left or right, the 3D avatar may move its head and twist its torso based on the angle. If the user is in the seated position, the user may have a limit on the angle in which they can move the view left or right. If the user is standing, there may not be a limit on the angle in which the user can move the view left or right. After the user has moved the view beyond an established angle, the 3D avatar may turn its legs to match with the head position.

When the user presses a move forward movement key, the avatar may move in the direction in which the avatar's head is currently facing. The avatar's body may turn to follow the movement. When the avatar is moving, avatar head movement functionality may be disabled.

When the right mouse button is not depressed, the user can move the mouse cursor to highlight any onscreen UI element. An interactive UI element may display a graphic indication of highlight when the mouse cursor is hovered above it. Left clicking on a highlighted UI element may activate that specific UI element.

During a meeting, the presenter can access a web browser and present the website to the other meeting attendees. When clicking on a media presentation screen, the user may have the option to access a web browser by means of an onscreen web browser button. When the presenter clicks on the web browser button they may enter the web browser interface. The web browser interface may allow for example: Direct text entry of a URL; Previous page; Reload current page; Google search. When the presenter enters the web browser interface, the web browser may appear on the media screen in the virtual world. Meeting attendees can click on the media screen to view the web page in full screen. This interface may be the same as viewing any other media on a media presentation screen. In one embodiment, one presenter may control a media screen at a time and thus only one presenter can be in the web browser interface per media screen. While the presenter is in the web browser interface, the new media, exit, and close media buttons functions the same as they do in the other media presentation interfaces.

There may be several internet access hubs located within the virtual lounge. A user can highlight and left click on an access hub in the virtual world. When the user clicks on the access hub they may enter the web browser interface. The web browser interface may allow for example: Direct text entry of a URL; Previous page; Reload current page; Google search. An exit button is present on the web browser interface screen Clicking on the exit button may close the web browser interface. Multiple users can access a single access hub simultaneously. Each user may have their own internet session and the displayed webpage(s) may not be viewable by other users.

This application may allow for seamless meeting creation and joining through a calendar and email application, such as Microsoft Outlook by means of a plug-in. This plug-in may allow for the following functionality when creating meetings. The user may be able to select an option within Outlook to create a Virtual Meeting. After selecting to create a Virtual Meeting, the user may be able to set the parameters of the following options: Meeting Type/Room; Attendees (same functionality as standard Outlook meeting requests); Attendee Roles; Time of Meeting; Length of Meeting; Private or Public Selection.

hen the user has finished setting the parameters of the Virtual Meeting and has clicked on the Send button, a meeting request e-mail may be sent to all of the requested attendees. The meeting request e-mail may contain the details of the scheduled meeting along with a quick link to the meeting. When an invitee accepts an invite it may appear in their calendar and they may receive reminders based on what parameters the creator has set. At the scheduled meeting time, the quick link may allow the attendee to click on the link and be directly transported into the meeting room. The same mechanics are used when the user is in game and selects to create a scheduled meeting. Microsoft Outlook may open overtop the application and may automatically open the appropriate plug-in and function as stated above.

In a scheduled meeting, the meeting room may be created after the first invitee (or creator) clicks at the e-mail hyperlink. Both the invitee and the creator may not be able to join the meeting until the appropriate meeting time (there may be a 15 minute buffer for allowable joining before actual meeting start time). When the creator joins the meeting they may be prompted to upload and attach any documents that they would like for the meeting. ter the meeting room has been created, users can also select to join the meeting through the virtual world by using the in-game meeting browser.

The external instance of a lounge may be exactly the same as the internal instance of the Lounge. No visuals or interactions may be changed in this new instance. The key change for users may be the authentication method of entering the game. External users' information may be stored in an excel spreadsheet for future logins. The storage may allow user permissions to be set by an administrator. The exact interface for external login or account creation may need additional technical and usability research.

This application may include an After Action Review (AAR) for users to replay any session for learning or review purposes. The recording of sessions may be taken from the client's view of the meeting. The After Action Review may include all actions made by users, all public voice traffic, whiteboard activity and all media presentations as witnessed by the user. The system may not record any whispered conversations or any text chats (as those take place in the Microsoft Communicator Application). The AAR may play from the user's perspective and may not allow for a free camera mode. Users may be able to view their own recorded sessions online or at any time offline. They may also be able to use a media browser to upload their own file to the server or to pull down AAR files uploaded by other users. Once these files have been pulled down they too can be viewed offline. When watching the AAR recording offline the user may need to have the original media contained in that session (.PDF and video files). If they do not have the original media, they may still be able to watch the session, but no media may be displayed. If media is updated or changed after the session is recorded the integrity of the session cannot be maintained.

The user may be able to pause the AAR, but may not be able to rewind or fast-forward the AAR. The users may have a number of fun features available to them in the game world: For example, users may change laser pointer color; use may have funny animations applied to their avatars; users may win rewards of object or other things for their avatars.

The whiteboard may be a feature accessible to users in Conference Rooms, Assessment Rooms, or Classrooms. The user may be able to interact with the whiteboard from anywhere within these rooms. One user may be able to interact with the whiteboard at a time. While interacting with the whiteboard, the user may see an interface window open on their screen. This window may allow that user to draw on the whiteboard using their mouse (or a touch screen interface) as the pen. Anything drawn on the whiteboard may be displayed to anyone in the meeting room.

While the active user is interacting with the whiteboard, all other attendees can still view the whiteboard, but the interface window may not allow them to draw. If another user wishes to draw on the whiteboard, the current user must close their interface window. The next user to interact with the board may receive the pen and be able to draw.

The laser pointer can be used to pinpoint specific areas on in world displays. The user may be able to access the laser pointer via a UI element or a hotkey. The laser pointer may display for everyone in the world within a certain distance. It may draw the path of the laser as well as the termination point on a surface. Dependant on development, the laser may dissipate after a distance yet to be determined.

Whisper Mode is an extension of the voice over IP communication system that allows users to communicate in a small group as if they were whispering. Users may be able to select other players to join their whisper channel, allowing those invited to communicate privately. No one outside of the whisper channel may be able to hear the conversation. An icon may be displayed on users' screens to display how many people they are communicating to.

This feature is only available to users within a certain radius of the other users in the group. If a user leaves that radius they may be removed from the whisper channel. This also applies in the Auditorium, only users within a certain distance of the initiating user may be able to join the whisper channel. Any whispered communications may not be recorded by the After Action Review system.

The user may see what we are calling Quest Stations in the Lounge environment. These virtual representations may be visually interesting and interactive in the virtual environment. To interact with Quest Stations the user simply clicks on them while inside a designated radius. Once clicked, the Quest Station may present the user with a pop-up text window displaying the quest requirements. The user needs to accomplish these requirements to get a reward.

The reward may be displayed on the Quest Station. Rewards can be pets that perch on, hover around, or follow the user. Rewards may be hairstyles, clothing, and accessories that the user can wear. Once the quest requirements are accomplished, the user can return to the Quest Station and obtain the reward. Each quest requirement may encourage the player to interact with the virtual environment. Partially completed quest requirements may have persistent data and display progress to the user. Quest requirements may include most of the interactions that we can track in the game world, including: Attend x number of meetings in Conference Rooms, Classrooms, or Auditoriums; Initiate x number of conversations in the Lounge with co-workers; Achieve level x in other games; Send x number of invitations to join rooms; Present in x number of meetings; Present x number of documents in meetings.

Once any particular set of quest requirements are completed, the respective reward is immediately displayed on the successful user. There may be an interface to choose which reward to display on a user once multiple rewards are acquired. Only one reward can be displayed at a time. Upon quest success, additional quests with new quest requirements may become available. As the user completes the quests, the quests may scale up, in both challenge and the visual appeal of their associated reward. As users complete tasks in the virtual environment, statistics and their actions may be recorded in their profile. These statistics can be pulled by a supervisor or manager to review their activity within the game world. There is a large amount of information that is possible to track for users. Examples of possible data to track are number of: Meetings attended in the Classroom, Conference Room or Auditoriums; Meetings hosted in the Classroom, Conference Room or Auditoriums; Whispers initiated; Whispers in which the user has-participated; Documents presented; Invitations sent.

### Example of Medical Consultation in a Virtual Environment:

1. Predictive models show the pharmacokinetic impact on each avatar
a. Life before your eyes: playing with kids, in ambulance, dead
b. Each avatar has a name
   2. Avatar Alexa walks out of lab, and into doctor office
a. Doctor is thinking, punching keys, making a decision
b. Lightbulb
   3. Real Alexa is at home on computer, clicks Appt
a. Alexa jumps inside her computer and appears in the virtual doctor office
b. Sitting next to avatar Alexa
   4. Doctor runs diagnostics, visuals, predictive models
a. Alexa gets tears in her eyes when she sees her children playing without her
   5. Doctor opens drug box
a. Out pops a med visual
b. Drops med onto the Alexa avatar, shows visual of results
c. Now Alexa sees visual of her life with kids
d. She is happy
   6. Doctor hands Alexa 2 RX's: one for pharm, one for web
a. Alexa drives to pharm, gets rx
b. Goes home, logs on
   7. Alexa connects wireless clip for HR, BP
a. Sees herself come to life on PC
b. Shows progress, realizes she is getting healthier
c. Data beamed to doctor and lab
   8. Alexa crosses finish line
a. Visual shows illness cured and RX protocol completed
b. But the road goes on: her life RX must persist
c. She is worried
d. Then Virtual Alexa comes to her side to help her
e. She is comforted

### ADDITIONAL EXAMPLES

1. “Unlocking” of Meeting Rooms based on usage
2. Retail Clothing brands—dress your digital form, click-to-buy real clothes. Product Placement in captive audience environments
3. 3D immersive environment to facilitate a gathering of attendees for the view. Interaction with, and discussion of, a 3D rendered model(e.g. Market event simulation)
4. 3D immersive Call Center
5. 3D Environment user-metrics
6. Who was here, how long, what did they do, who did they talk to, etc
7. Persisted-State conference rooms
8. Research, war room, etc
9. “Preserve” feature enables persistence of user changes(documents, files, etc)

### PHARMACEUTICAL INDUSTRY EXAMPLE

1. Use of 3D interactive digital forms for branded drug promotion and usage monitoring.
2. Differential Analysis using EMR+Physiologically correct digital form+pharmakinetic drug models
3. Prescription-only Web Access(WX)
4. For use in combination with RX
5. RX+WX=Outcomes
6. Use of 3D immersive environments for clinical lab trials
7. Use of 3D immersive environments for day clinical trials
8. Improve patient engagement in remote-monitoring schemes
9. Integration of biomechanical remote monitoring devices as an input device to physiologically correct rendered digital forms
10. Use of 3D immersive environments to target Patient Outcomes including
11. Adherence/Compliance/Persistence
12. Education
13. Community
14. Communication
15. Visualization

### HEALTHCARE EXAMPLE

Immersive 3D Online Consultations may be implemented using the virtual reality models described herein. An online consultation mechanism may be used to redirect and optimize the use of in-office doctor visits. And provide enhanced services to Cash-for-Consult, phone based medical care. 3D immersive/interactive environments may overcome deficiencies inherent to in-office doctor visits including: patient education(drugs, illness, history). Integration of physiologically correct digital forms with pharmakinetic drug models may provide doctor and patient interactive simulations. Interactive visualization of “unseen” medical conditions(cholesterol, blood pressure, etc) may be presented through the virtual environment interaction with the user's medical information. Patient medical record visualization/interaction via 3D digital form. An adherence programs based on patient adherence history may be facilitated in a virtual environment. Use of 3D Immersive environments to combat chronic illness such as Obesity/cancer may be implemented. “Engagement Skins” may be used to adapt immersive environments to match Patient Adherence program requirements. An online questionairres may be used to collect of Patient Adherence History. A 3D Immersive environment may be used to facilitate Medical Meetings. A 3D Immersive environments to may provide a “zero value” alternative to meeting attendees who are required by regulation or other pressures to account for all “gifts” received. A 3D immersive technology may integrate wellness programs to provide a seamless overlay to integrate the full lifecycle of patient care: Doctor chart entry+EMR+RX+Adherence.

### EDUCATION EXAMPLE

3D immersive environment to model a learners course-based curriculum
3D visualization and interaction with LMS based course offerings, scheduled, etc
Use of 3D immersive environments as a more effective authentic testing mechanism for standardized tests(SAT, ACT, etc)
3D immersive environments for the benefit of distance education

### Education Arcade

### Educational Game Space

### CORPORATE ENTERPRISE EXAMPLE

Multi-sensory immersive data visualization tool that uses output from search, text analytics and data mining to create a multi-sensory data visualization experience for benefit of more intuitive differentiation of complex signals

### Finance

Use of 3D immersive environments for the broadcast of streaming and pre-recorded presentations by “in demand” speakers
Use of 3D immersive environments for the aggregation and access of ‘in demand” speaker presentations
Like a shopping mall, where everything is visible, but some stores maybe locked to certain users based on subscriptions(like Bond Hub)
Provide VOC feedback to publishers RE subscriber activity
Use of 3D immersive environments for consultations as Service provided by:

### Financial Advisors to Clients

### Private Bankers to Customers

### Hedge Fund Managers to Customer

### TRANSPORTATION EXAMPLE

3D immersive environments for Seat Selection on airplane
Booking/Seat Selection concierge “meet and greet”
Immersive seat selection as tool for “upselling” premium class

Airport lounge private meeting rooms for customers
Mobile Airline concierge for “instant in-environment access” to Booking Concierge Iphone/Sony PSP environment connected through Wifi to enable communication with Booking

### Agent

White labeled devices distributed by Airline to VIP travelers

### HOSPITALITY EXAMPLE

Concierge Tour for the benefit of room and amenity selection

### Casino—High Roller

Spa, etc
Use of 3D immersive environments for the benefit of restaurant, show, movie, sports seat selection
Restaurant chain(conglomerate)—Concierge to convert fully booked restaurant overflow to sister-properties(“let me show you a table at our property next door, I am sure I can find a special table for you there. Follow me)

### SERIOUS GAMES EXAMPLE

3D immersive environment game for Youth Social Modeling
Roleplay/Scenario based game for teenage girls to explore their interaction and experience in current and future relationships

### Childhood Obesity Game

Use of 3D immersive game design for the benefit of targeting childhood obesity
Process to employ captivating gaming techniques to instill “Streetwise” decision making skills in youth, with the recognition that we may not fundamentally change behavior, but we can enforce positive adjustments
Gameplay is a story board modeled after gaming hit(grand theft auto) incorporating teaching-moments using an “eat this, not that” concept.

### CASINO/GAMING EXAMPLE

High-roller meet and greet for Premium Service experience

### Corporate Infirmary

1. Aggregation of in-house service providers over remote distances
2. Including aggregation of external providers with in-house
3. Accessible corporate health services from any location

In an embodiment where the computer system includes a plurality of routers, the method may comprise arranging a router status area as part of the computer system status area. The router status area may identify information about the overall flow of packets of data through the administration server. The router status area may also identify information about the elapsed time since the last user logged into the computer system. The router status area may also identify the average quantity of data for each user handled by routers of the telecommunications network. A data processing system can be used to simulate a real or imaginary system and provide an environment for a user to interact with the simulated system. A user can perform operations on the simulated system, explore the simulated system and receive feedback in real time. Actual or fantasy 3-D environments may allow for many participants to interact with each other and with constructs in the environment via remotely-located clients. One context in which a environment may be used is in connection with gaming, although other uses for environments are also possible as described herein.

In a virtual environment, the environment is simulated within a computer processor/memory. Multiple people may participate in the environment through a computer network, such as a local area network or a wide area network such as the Internet. Each player selects an “Digital form” which is often a three-dimensional representation of a person or other object to represent them in the environment. Participants send commands to a environment server that controls the environment to cause their Digital forms to move within the environment. In this way, the participants are able to cause their Digital forms to interact with other Digital forms and other objects in the environment.

An environment often takes the form of a virtual-reality three dimensional map, and may include rooms, outdoor areas, and other representations of environments commonly experienced in the physical environment. The environment may also include multiple objects, people, animals, robots, Digital forms, robot Digital forms, spatial elements, and objects/environments that allow Digital forms to participate in activities. Participants establish a presence in the environment via a environment client on their computer, through which they can create an Digital form and then cause the Digital form to “live” within the environment.

As the Digital form moves within the environment, the view experienced by the Digital form changes according to where the Digital form is located within the environment. The views may be displayed to the participant so that the participant controlling the Digital form may see what the Digital form is seeing. Additionally, many environments enable the participant to toggle to a different point of view, such as from a vantage point outside of the Digital form, to see where the Digital form is in the environment.

The participant may control the Digital form using conventional input devices, such as a computer mouse and keyboard. The inputs are sent to the environment client which forwards the commands to one or more environment servers that are controlling the environment and providing a representation of the environment to the participant via a display associated with the participant's computer.

Depending on how the environment is set up, a digital form may be able to observe the environment and optionally also interact with other digital forms, modeled objects within the environment, robotic objects within the environment, or the environment itself (i.e. an digital form may be allowed to go for a swim in a lake or river in the environment). In these cases, client control input may be permitted to cause changes in the modeled objects, such as moving other objects, opening doors, and so forth, which optionally may then be experienced by other Digital forms within the environment.

“Interaction” by a Digital form with another modeled object in a environment means that the environment server simulates an interaction in the modeled environment, in response to receiving client control input for the Digital form. Interactions by one Digital form with any other Digital form, object, the environment or automated or robotic Digital forms may, in some cases, result in outcomes that may affect or otherwise be observed or experienced by other Digital forms, objects, the environment, and automated or robotic Digital forms within the environment.

A environment may be created for the user, but more commonly the environment may be persistent, in which it continues to exist and be supported by the environment server even when the user is not interacting with the environment. Thus, where there is more than one user of a environment, the environment may continue to evolve when a user is not logged in, such that the next time the user enters the environment it may be changed from what it looked like the previous time.

environments are commonly used in on-line gaming, such as for example in online role playing games where users assume the role of a character and take control over most of that character's actions. In addition to games, environments are also being used to simulate real life environments to provide an interface for users that may enable on-line education, training, shopping, business collaboration, and other types of interactions between groups of users and between businesses and users.

As Digital forms encounter other Digital forms within the environment, the participants represented by the Digital forms may elect to communicate with each other. For example, the participants may communicate with each other by typing messages to each other or an audio bridge may be established to enable the participants to talk with each other.

There are times when it would be advantageous for web content to be displayed within the environment. For example, if the environment is used in a retail capacity, it may be desirable to display web content about particular products within the environment. Unfortunately, environment engines are typically engineered with the assumptions that textures (bitmaps on 3D surfaces) do not change regularly. Thus, although the web content may be mapped to a surface as a texture, updating the content and enabling users to interact with the content is challenging.

In a business context, where the three dimensional environment is being used for business collaboration, it is important for the users to have a consistent view of the environment. It is difficult for people to collaborate if they are looking at different things. Where web content is to be included in the environment, it therefore is important that the same web content be shown to all viewers.

An environment can offer users immersion, navigation, and manipulation. A environment can make the users feel that they are present in the simulated environment and their visual experience in the environment more or less matches what they expect from the simulated environment, a sensation sometime referred to as engagement or immersion.

Examples of environments include various interactive computer environments, such as text-oriented on-line forums, multiplayer games, and audio and visual simulations of a system. For example, a personal computer can be used to simulate the view of a three-dimensional space on a computer screen and allow the user to virtually walk around and visually inspect the space; and via a data communication network many users can be immersed in the same simulation, each perceiving it from a personal point of view.

Some environments support a Massively Multiplayer Online Role Playing Game (MMORPG), in which a user represented by an digital form can interact with other users who are also represented by their corresponding digital forms. Controlled by an input device such as a keyboard, an digital form can move in the environment and even fly around to explore, meet people, engage in text chat, etc. To simplify the navigation process, an digital form may also be teleported directly to a specific location in the environment. When an digital form representing a different person is in the view, this person/digital form can be selected to start a conversation (e.g., text chat).

A digital form includes an image that represents a user. The appearance of an digital form may or may not resemble the user. An digital form may be in the shape of a human being, a cartoon character, or other objects. An digital form may be based on one or more photographs of the user. For example, a photo image of a user may be mapped to generate an digital form that simulate the look and feel of the user. Alternatively, an digital form may not have any resemblance with the actual appearance of the user, to allow the user a complete different life in a community.

In one embodiment, an advertisement is presented in a environment. The advertisement includes a communication reference which can be used to request a connection provider to provide a connection for real time communications with the advertiser.

In one embodiment, the communication reference is embedded in the advertisement to represent an address or identifier of the connection provider in a telecommunication system. When a call to the reference is made via the telecommunication system for a real time communication session, the call is connected to the connection provider. The connections provider may associate different communication references with different advertisers and/or advertisements so that the advertiser can be identified via the communication reference used to call the connection provider. After identifying the contact information of the advertiser based on the communication reference used to call the connection provider, the connection provider can further forward, bridge, conference or connect the call to the advertiser.

The connection provider can thus track the connections for real time communications with the advertiser, made via the communication reference embedded in the advertisement that is presented in the environment. The connections provided by the connection provider can be considered as communication leads provided to the advertiser via the advertisement; and the advertiser can be charged based on the delivery of leads to real time communications with customers.

In one embodiment, advertisers may specify bid prices for the communication leads received; and the presentation of the advertisement and the connection of calls can be prioritized based on the bid prices of the advertisers. In one embodiment, the advertisers may specify the rules or limits for the bid prices to allow the system to automatically determine the actual bid prices for the advertisers based on the bids of their competitors.

System and method are provided that allow a user to transition seamlessly between different interactive experiences presented by different viewers. By storing state information related to the applications and event handlers of the different interactive experiences in their respective viewers, the user can transition from an original experience to a new experience and then back to the original experience seamlessly, without perceptible delay, and without losing information concerning the user's state within any of the experiences presented by any viewer.

In some embodiments, a first viewer is activated to define and render a visualization of a first interactive experience to a user. At least one first application is selected for use with the first interactive experience and at least one first event handler associated with the first application is responsively activated. Subsequently, state information is responsively stored in the first viewer concerning the selected first application and first event handler. The first viewer, the first application, and the first event handler are thereafter deactivated. A second viewer associated with a second interactive experience is then activated.

The second viewer may then be deactivated at a later time and the first viewer may then be re-activated. The selected first application and the selected first event handler may be re-activated using the stored state information concerning the first application and the first event handler stored in the first viewer.

In one example, the visualization presented to a user comprises a room. In other examples, the visualization may be other areas such as buildings, parks, or areas of cities. Other types of visualizations may also be presented.

The first application may be selected by receiving a client application selection triggering event and determining the first application, as a function, at least in part, of the client application selection triggering event. The client application selection triggering event may originate from a device such as a keyboard, computer mouse, track ball, joy stick, game pad, or position sensor. The application may be any type of application such as an email application, video display application, document display application, location visualization application, or a security camera display application.

By storing state information related to the applications and event handlers of interactive experiences in their respective viewers, the user can transition from an original interactive experience to another interactive experience and then back to the original interactive experience seamlessly, without substantial delay, and without losing information simply by activating the respective viewers associated with those interactive experiences.

In one embodiment, there are systems and methods that provide for a entertainment system that supplies immersive entertainment and creates a sensation for a user similar to having guests in a remote location to be physically present as guests. Such entertainment system can supply a graphic and/or audio; wherein interconnected computers, video and audio processing devices, supply a live interaction between a user and a guest(s). Although guests are only present virtually (e.g., electronically present with other objects/user within the environment) such invitation enables a user and guests to concurrently experience the entertainment together (e.g., a live sporting event, spectator game). In it also possible to implement holographic digital forms, and a plurality of communication interfaces, to imitate (and/or transform) a relationship between the user and the guests/surrounding environment.

In various embodiments, systems and methods supply immersive entertainment, and create a sensation for a user(s) that is similar to having guests (who are in remote locations), to be presented as guests to the user during performance of an event (e.g., a live sporting event, spectator game, television shows, games and the like)—via employing a presentation system and a generation component. Such generation component emulates activities of guests (e.g., implement holographic digital forms via a plurality of communication interfaces to imitate actions of guests, and/or accepts functions provided to transform the activities, and the like). The presentation system can present such activities to the user, (e.g., activities of the guest can be viewed, heard, felt, or otherwise presented to the senses of the user.) In addition, transform functions for activities can be supplied dynamically (e.g., based on type of events)—for example transformation functions applied to guests enable creation of a variety of scenarios (e.g., change of digital form representation, appearance of the guest and the like.)

In various embodiments, a interactivity system and method of operation includes a plurality of position indicators that indicates a plurality of positions in a physical coordinate system each being associated with one of plurality of objects located within the physical environment mapped by the physical coordinate system. The system may also include a position communication system that communicates the plurality of positions of the plurality of position indicators. The system may also include a user module associated with a user positioned within the physical environment. The user module determines a position of an object within the physical coordinate system as a function of the plurality of position signals. The user module determines a position of an associated object within the coordinate system and generates a image signal that includes the determined position of the associated object within the coordinate system. The user module may also include a user interface that displays a image to the user as a function of the image signal.

While particular embodiments of the invention have been shown and described, it may be understood by those having ordinary skill in the art at the embodiments are illustrative and that changes may be made to those embodiments without departing from the spirit and scope of the present invention.

What is claimed is:

1. A method of providing a medical consultation in a virtual environment, comprising:
providing an avatar representing a medical professional and a patient;
providing an appointment room;
allowing the medical professional access to patent medical information through the virtual environment; and
depicting visual information regarding the patient's condition in the virtual environment.

2. The method of claim 1, further comprising:
establishing voice communications between the patient and the medical professional through the virtual environment.

3. The method according to claim 1, further comprising:
presenting, based on medical information associated with the patient and medical treatment information provided by the medical professional, a predictive visual display relating to the patient's health and treatment.

4. A method of providing a virtual environment comprising multiple rooms and areas for interaction among avatars, comprising:
at least one virtual lounge area;
at least one virtual meeting room;
at least one browser for permitting users to select, via an avatar and a browser tool in the virtual environment, a virtual lounge or virtual meeting room to join.

5. A method of displaying a user-specified conversation involving a plurality digital forms in a simulation environment during a simulation in which each of a plurality of users participate, each of the users using a separate one of a plurality of processing systems on a network to control a separate one of the digital forms, the method comprising: storing data defining a prop to facilitate the user-specified conversation between the digital forms, the prop including a plurality of associated slots, in proximity to each other, at which an digital form can be placed to facilitate the conversation, and a plurality of viewpoints in proximity to the plurality of associated slots and defined relative to the prop, each of the viewpoints to provide a view during the simulation, at least one of the viewpoints to provide a view directed to one of the slots; and placing the prop in the simulation environment during the simulation; placing each of the plurality of digital forms in a separate one of the slots in the prop during the simulation; generating a view of a first digital form controlled by a first user from a first viewpoint of the plurality of viewpoints during the simulation; and automatically changing the view from the first viewpoint to a second viewpoint of the plurality of viewpoints, in response to a user-initiated action of a second digital form controlled by a second user, where the second viewpoint differs from the first viewpoint in field of view or distance to subject or both, such as to give the second viewpoint a different zoom from the first viewpoint, to emphasize an element of non-verbal digital form communication.

6. A computer system for implementing a environment, said computer system comprising: a computer server complex comprising a plurality of servers running software to provide at least one environment within the environment, and a patch server; a plurality of user computers each including a processor and software for providing an interface to the environment; and a network through which the plurality of user computers may connect to the computer server complex, said patch server including software updates to be transmitted to at least some of the user computers for interfacing with the environment.

7. A method, comprising: associating an digital form with an application; determining a location of the digital form in a environment; and determining whether an advertiser of the application is available for real time communications based at least in part on the location of the digital form in the environment.

8. A method of facilitating transitions between multiple interactive experiences comprising:
activating a first viewer to define and render a visualization of a first interactive experience to a user; selecting at least one first application for use with the first interactive experience and responsively activating at least one first event handler associated with the at least one first application; subsequently responsively storing state information concerning the selected at least one first application and the at least one first event handler in the first viewer; deactivating the first viewer, the at least one first application, and the at least one first event handler; and
activating a second viewer associated with a second interactive experience.

9. A computer-assisted method of designing a product to be worn by an individual, comprising:
selecting a population of digital forms, wherein each digital form provides a representation of at least a portion of a human body, and wherein the population of digital forms is representative of a population of individuals; obtaining a set of data describing a product to be worn by the individuals in the population of individuals; and for each digital form, in the population digital forms: generating a simulation that simulates a digital form interacting with the product, and analyzing the interaction between the digital form and the selected product to evaluate at least one a performance characteristic of the product.

10. A user interface comprising: a display having a transparent mode and a display mode, said transparent mode providing transparent viewing to a user of the VR user interface, said display mode displaying a image; and an audio interface generating an audible sound.

11. A computer-implemented method of including web content in a three-dimensional computer-generated environment, the method comprising the steps of:
obtaining the web content by a web browser instantiated on the computer;
storing the web content into a buffer on the computer; and
rendering, by a environment client, the web content onto three dimensional computer-generated environment,
wherein the environment includes virtual lounges and meeting rooms, and browser tools in the environment for selecting an available one of the virtual lounges or meeting rooms.

12. A method, further comprising:
storing information relating to user preferences and information regarding a wide variety of applications.
